(19) United States
(12) Patent Application Publication
(10) Pub. No.: US 2025/0230863 A1
(43) Pub. Date: Jul. 17, 2025

(54) DRIVE UNIT AND COMBINATION OF DRIVE UNITS

(71) Applicant: Schindler Holding GmbH & Co KG, Plüderhausen (DE)

(72) Inventors: Jürgen HAAK, Plüderhausen (DE); Ralf Peter MÜLLER, Plüderhausen (DE); Jens SCHINDLER, Plüderhausen (DE)

(73) Assignee: Schindler Holding GmbH & Co KG, Plüderhausen (DE)

(21) Appl. No.: 18/926,630

(22) Filed: Oct. 25, 2024

(30) Foreign Application Priority Data
Oct. 26, 2023 (DE) 10 2023 129 620.5

(51) Int. Cl. F16H 37/02; F16H 57/02; F16H 57/021; F16H 57/025; F16H 57/029; F16H 57/031; F16H 57/04; H02K 5/10; H02K 7/10; H02K 7/116; H02K 9/22; H02K 11/33

(52) U.S. Cl. CPC F16H 37/02; F16H 57/021; F16H 57/025; F16H 57/029; F16H 57/031; F16H 57/0415; F16H 57/0416; F16H 57/0476; H02K 5/10; H02K 7/1004; H02K 7/116; H02K 9/225; H02K 11/33; F16H 2057/02034; H02K 2205/09

(57) ABSTRACT

Drive unit (20) in the form of a driven drum (5), wherein provided within the drive unit (20) is a motor (6) and the outer side is configured as a smooth drum (5), a belt pulley, a cogged-belt pulley, a gearwheel and/or a chainwheel, as well as a combination of plurality of drive units, wherein individual drive units (20) are securable to a bracket (51) by means of a defined interface with respect to mechanical securing, energy supply, lubricant supply and heat dissipation and thus form a combination of several drive units (20).

The invention relates to a drive unit in the form a driven drum.

Various drive units of that kind are known, which, however, are of very large construction, are intensive with respect to cleaning and to an extent are also susceptible to fault.

The object of the invention is to propose a compact drive unit which above all can be used for drive of transport belts particularly in a field with increased demands on hygiene. Other applications are conceivable.

According to the invention this object is fulfilled in that a motor is provided within the drive unit and the outer side is configured as a smooth drum, a belt pulley, a cogged-belt pulley, a gearwheel and/or a chainwheel.

Thus, all possible transport belts and also other devices can be driven by means of the drum.

In that case it has proved very advantageous if the motor is configured as a drum motor.

A drum is universally usable as a drive and also able to be cleaned in very simple manner.

According to the invention it is extremely advantageous if the motor has the configuration of a geared motor.

As a result, it is also possible for higher forces and low speeds to be realised.

According to an advancement of the invention it is also very advantageous if the motor axle is configured to be mounted at one end.

The drive unit can thereby be of very compact construction and yet well secured.

It has also proved especially advantageous if the ratio of drum width to drum diameter is less than 2 and preferably amounts to between 1 and less than 0.5.

Straight transport belts can thereby be driven particularly satisfactorily. In the ideal case the drive unit is only as wide as the transport belts.

According to a further embodiment of the invention it is also very advantageous if the motor axle is of hollow configuration.

A hollow motor axle can be used very well and imparts a high degree of stability to the drive unit.

According to a further development of the invention it is also very advantageous if an angle measuring device, which is preferably arranged in the motor axle, is provided.

As a result, the exact position of the drum of the drive unit can be ascertained at any time. Scenarios which use a defined rotational speed can be developed.

A further very advantageous embodiment of the invention is present if an electric motor, which is preferably arranged in the hollow axle, is provided as a drive in the drive unit.

The drive unit can thereby be driven in very satisfactory manner.

Moreover, it has proved particularly advantageous if a single-stage or multi-stage transmission, particularly a cylindrical gear transmission, a planetary transmission, a cycloid transmission and/or an eccentric transmission, is arranged, preferably at the end of the axle.

The cylindrical gear transmission functions as a speed step-down or step-up translation and thus forms the transmission of the drive unit.

In that case it has proved very advantageous if the transmission comprises a plurality of gearwheels operating in parallel.

These multiple gearwheels operating in parallel make possible a very high level of transmission of force in conjunction with low wear.

According to the invention it is also extremely advantageous if an axle suspension projects at one side or at multiple sides radially beyond the drum diameter.

A very satisfactory securing of the axle suspension can thereby be realised. In addition, heat can be dissipated via the axle suspension.

According to the invention it is also extremely advantageous if a flange plate for securing the axle suspension is provided.

The flange plate can, for example, be screw-connected with a support. Angular flange plates or axle suspensions are also conceivable.

According to a further advancement of the invention it is also very advantageous if feed and discharge lines of the motor are configured to be led out laterally beyond the axle.

The motor can thereby be very readily connected. Apart from electrical lines, lubricant supply lines are also conceivable.

A further very advantageous embodiment of the invention is present if heat conducting devices, particularly heat pipes for conducting away generated heat, are provided.

Waste heat arising during operation of the drive unit can thereby be very satisfactorily conducted away. The heat conducting lines can in that case also be led out beyond the axle.

According to a development of the invention it is also extremely advantageous if a thermal insulation between the hollow axle and drum is provided.

Heat transfer between the hollow axle, which is heated due to operation of the drive motor in the hollow axle, and the drum being driven is thereby reduced. In that case temperatures at or in the hollow axle in the region of a 100° C. can arise.

A further very advantageous embodiment of the invention is present if the side of the drum remote from the motor axle is closed by a closure cover.

The interior of the drum, transmission and electric motor is protected by the closure cover. In addition, intrusion or entry of foreign bodies is prevented.

According to a development of the invention it is also very advantageous if a stub shaft is arranged on the side of the drum remote from the motor axle.

In that regard it has proved extremely advantageous if drive take-off devices and/or support bearings are provided on the stub shaft.

The stub shaft can drive further devices. For that purpose clutches, belt pulleys, gearwheels or other couplings can be provided. Loading of the hollow axle is reduced by a support bearing. The stub shaft can be combined with a closure cover for the drum. It is conceivable for the stub shaft to be screwed, detented or connected in another manner with the drum.

Moreover, it has proved extremely advantageous if a ventilation, which is preferably realised by the axle suspension, of the drum body is provided.

Pressure fluctuations, which would otherwise arise due to temperature fluctuations, in the drum body are avoided by the ventilation. The ventilation ensures pressure equalisation. If the ventilation is via the axle suspension then the drum is ventilated outside the work region and is thus protected. Foreign bodies and liquids, which can occur during cleaning of the drive unit, are thus not capable of penetrating.

According to a further advancement of the invention it is also particularly advantageous if a seal between the drum and axle suspension is provided.

Penetration of foreign bodies and liquids into the drive unit is effectively prevented by means of such a seal. Cleaning media under high pressure are often used particularly for the cleaning of plants which process foodstuffs. Penetration into the drive unit is thus prevented.

According to a further advancement of the invention it has also proved particularly advantageous if the transmission is configured to be self-locking and/or a motor brake is provided.

The drive unit is thereby safeguarded against reverse rotation and also blocked.

A very advantageous combination of a plurality of drive units according to the invention is present when individual drive units are securable to a bracket by means of a defined interface with respect to mechanical securing, energy supply, lubricant supply and heat dissipation and thus form a combination of several drive units.

Thus, several drive units can also be connected to form an overall system.

In that case it has proved particularly advantageous if the bracket is equipped with an electronic control system, a lubricant supply and/or a cooling system for the individual drive units.

The construction is thus modularised and can be cleaned, maintained and kept in service particularly simply.

According to an advancement of the invention it is also extremely advantageous if the cooling system is configured with heat exchangers for coupling to the individual drive units.

Individual drive units can thereby be exchanged without a great amount of effort. The heat exchanger can be provided in the drive units or also in the bracket.

Moreover, it has proved very advantageous if a common energy supply for the combination is provided.

By virtue of a common energy supply, which can be distributed in the bracket to the individual drive units, the construction is significantly simplified.

According to the invention it is also very advantageous if the cooling system conducts the generated heat outwardly away to a provided point.

The arising heat can, for example, thus be conducted out of the product area or hygiene area. It is also conceivable for the combination to discharge the heat to a superordinate cooling system so that a production facility is not unnecessarily heated.

Furthermore, it has proved very advantageous if a common ventilation of the drive units and the bracket is provided.

Penetration of liquids and foreign bodies is thus also prevented. Pressure equalisation of the individual drive units thus takes place centrally at a protected point. The same applies to the bracket on which several drive units are fastened.

The invention is explained in the following by way of an embodiment, in which:

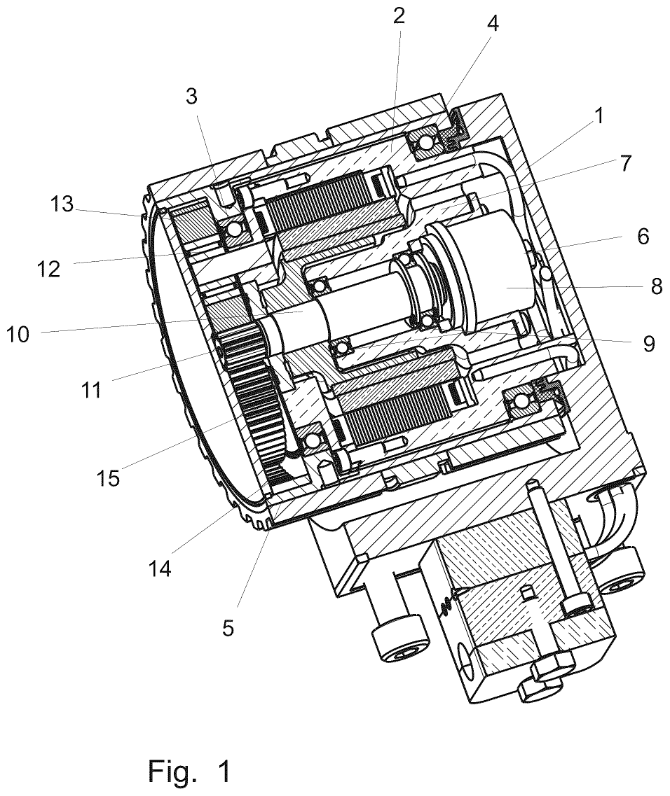

FIG. 1 shows a cut-away diagram of a drive unit according to the invention,

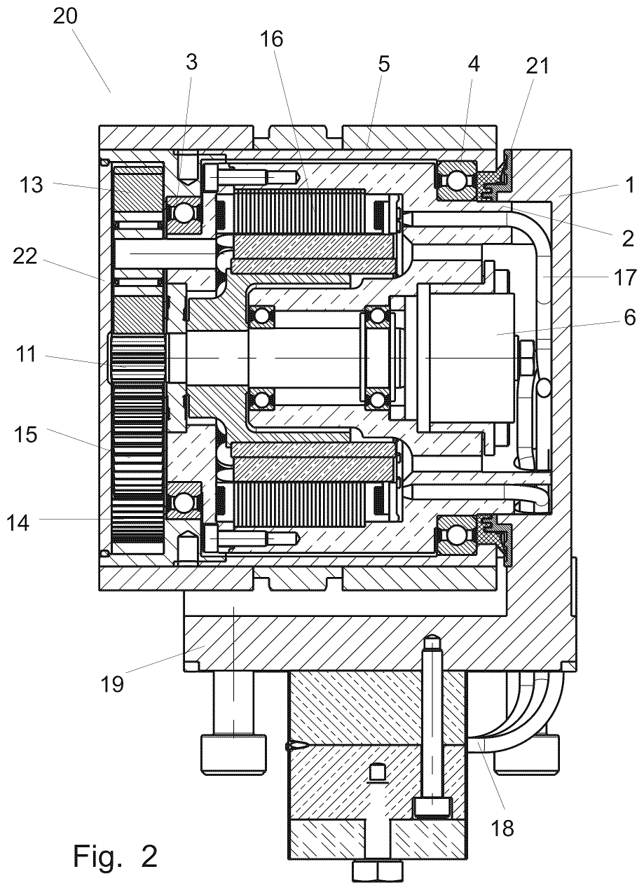

FIG. 2 shows a sectional depiction of the same drive unit,

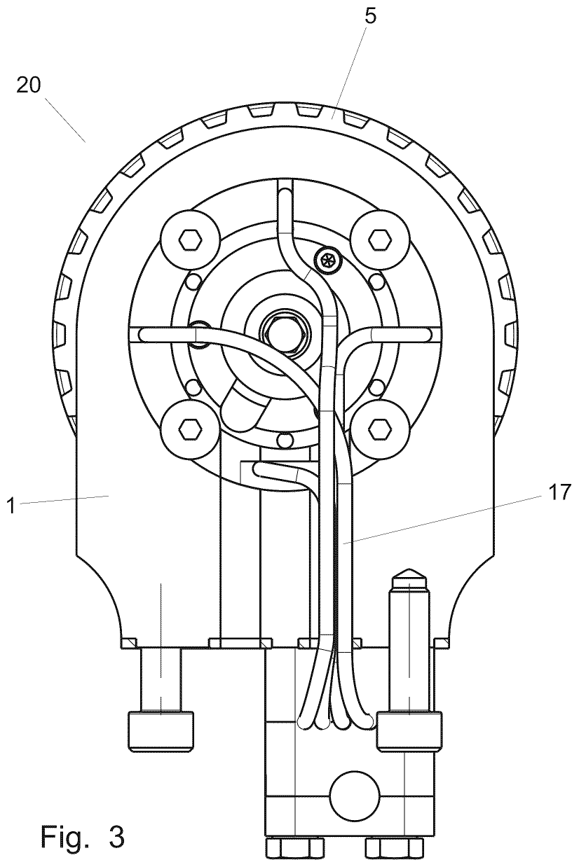

FIG. 3 shows a back view of the drive unit,

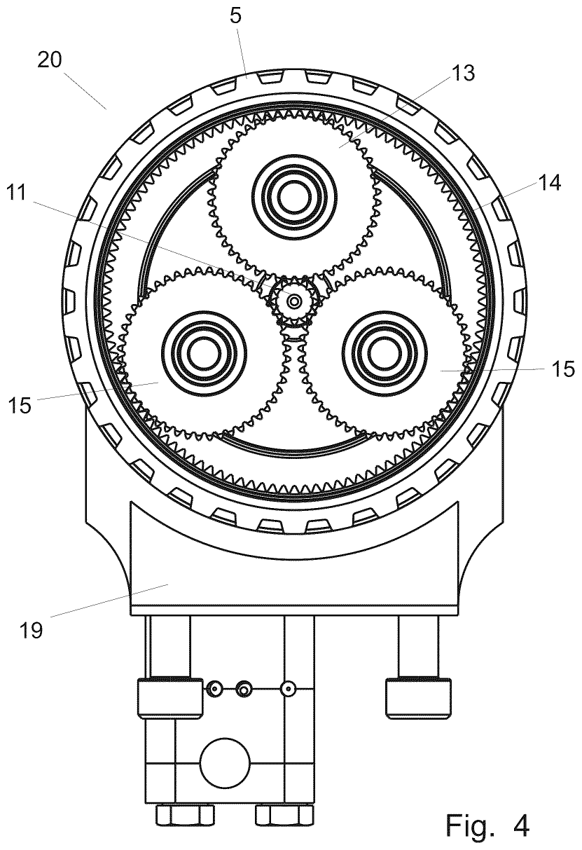

FIG. 4 shows an opened front view of the drive unit,

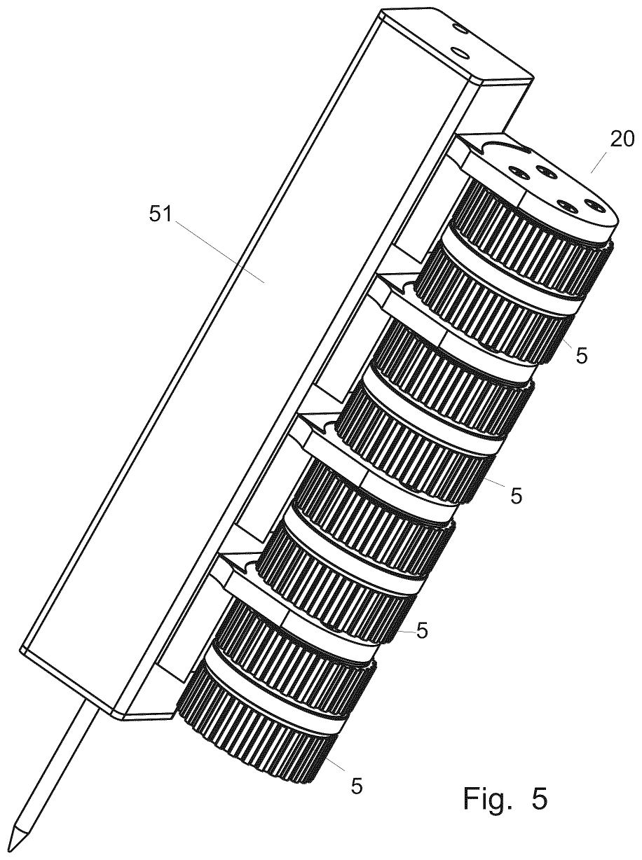

FIG. 5 shows a combination of a plurality of drive units secured to a bracket, as a diagram,

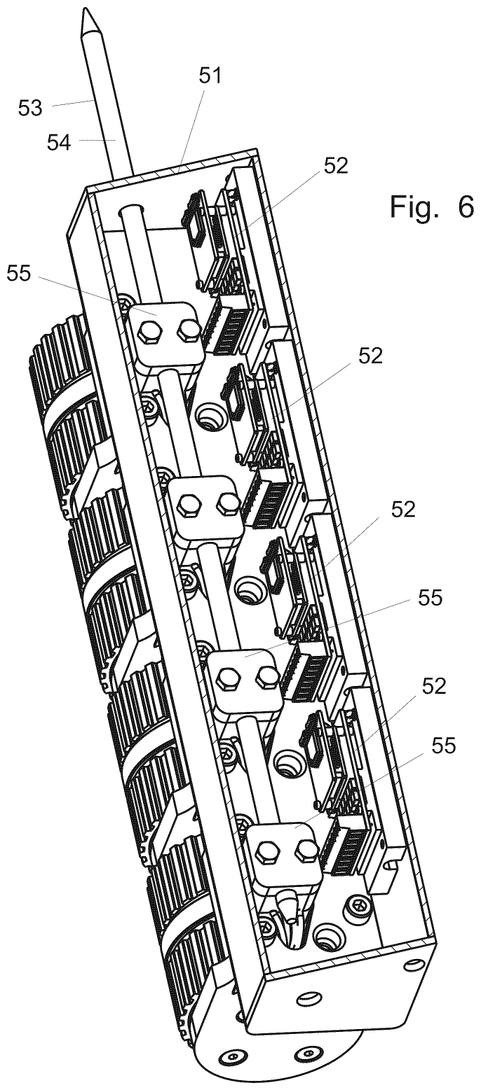

FIG. 6 shows a view into the bracket,

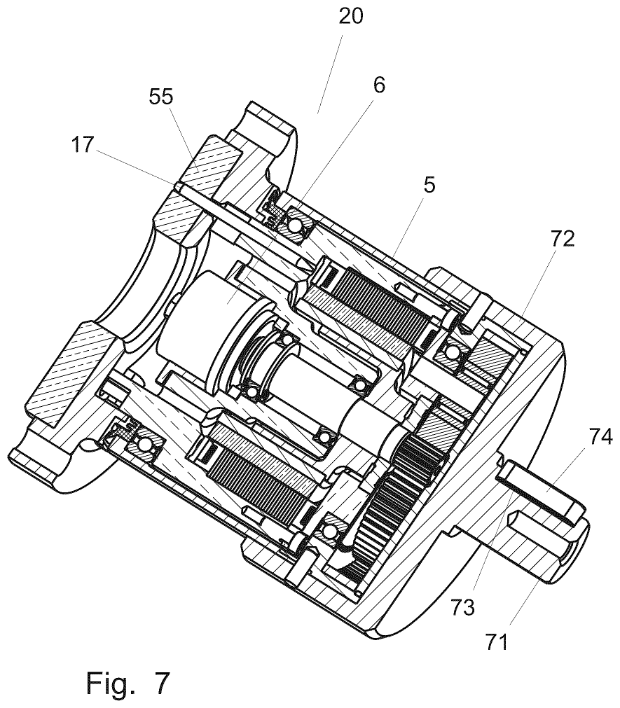

FIG. 7 shows a section through a drive unit with a fitted drive stub shaft and

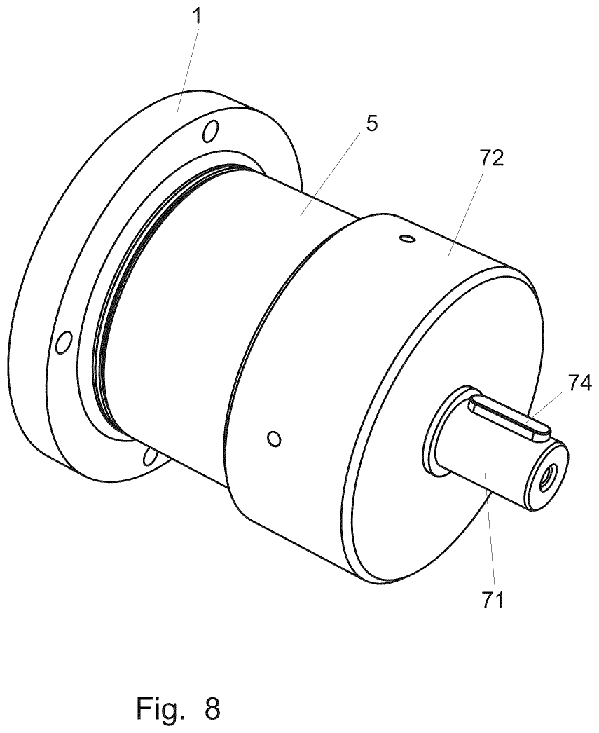

FIG. 8 shows a diagram of this drive unit.

A support plate to which a hollow axle 2 is secured is denoted by 1 in FIG. 1. A drum 5 is rotatably mounted on the hollow axle by way of two ball bearings 3 and 4. An electric motor 6 consisting of a stator 7 and rotor 8 is arranged in the hollow axle 2. The rotor 8 is in that case rotatably mounted in the stator 7 by way of two ball bearings 9. The rotor 8 goes over into a motor shaft 10, on the end of which facing away from the support plate 1 a gearwheel 11 is arranged to be secure against relative rotation.

The gearwheel 11 in that case acts on a further gearwheel 13 rotatably retained at the hollow axle 2 by way of a bearing 12. This gearwheel 13 for its part engages in an internal ring gear 14 of the drum 5.

In this way the rotor 8 drives the drum 5.

In addition, also provided in this embodiment are two further gearwheels 15 which are arranged to be uniformly distributed in the internal ring gear 14 of the drum 5. These gearwheels 15 support the motor shaft 10 and ensure a particularly uniform transmission of force. In this embodiment the gearwheels 15 are not journalled, but merely secured against axial displacements. However, normal journalling is conceivable and customary.

By virtue of the fixing of the gearwheel 13 in a fixed location the position of the gearwheels 15 also remains constant in operation.

In this connection it is also conceivable to dispense with the gearwheels 15. It is just as conceivable that, apart from the gearwheels 15, also the gearwheel 13 is not journalled, so that a planetary transmission results.

Other transmission configurations such as a cycloid transmission and an eccentric transmission are also conceivable, such as single-stage and multi-stage transmission configurations.

In addition, but not illustrated, a rotational angle transmitter enabling determination of the respective drum position can also be provided in the hollow axle 2.

Moreover, cooling bodies 16 which are capable of taking up waste heat of the electric motor 6 and discharging it by way of heat pipes 17 are also arranged in the hollow axle 2. However, it is also conceivable for heat to be dissipated by way of the hollow axle 2 and the support plate 1.

A high level of power density can be realised by this cooling without the drive unit overheating. Nevertheless, temperatures of around 100° C. in the interior are conceivable.

A thermal insulation (not illustrated) which reduces heating of the drum surface and thus minimises heat transfer to a transport belt can be provided between the hollow axle 2 and drum 5. In addition, heating in the work area of the plant driven by the drive unit is also reduced. Particularly in the case of plants processing foodstuffs this offers the advantage that the foodstuffs are not unnecessarily heated.

The electric motor 6 is supplied with electrical energy by way of feed lines 18. These feed lines 18 are led to the outside through the hollow axle 2 and the support plate 1.

The support plate 1 projects beyond the diameter of the drum 5 in at least one direction. A securing flange 19 is integrally formed there at the support plate 1.

Ideally the feed lines 18 are led through the securing flange 19.

The heat pipes 17 are also led over the hollow axle 2, the support plate 1 and the securing flange 19.

A line (not illustrated) for lubricant supply is also conceivable. This can also be led over the support plate 1 and the hollow axle 2. Lubricant can be fed through this lubricant line primarily to the gearwheels, but also to bearings.

Apart from the above-mentioned rotational angle transmitter, further sensors and protective devices can also be provided.

All of these together form the drive unit 20.

The drum 5 extends in its axial dimension almost over the entire width of the drive unit 20. In that case the drum 5 directly adjoins the support plate 1. A seal 21, which for example is executed as a radial seal, can be arranged at this location. This seal 21 prevents dirt or the like from penetrating into the drive unit 20. This is important particularly in the case of plant cleaning, since the cleaning is often carried out with liquid cleaning media under high pressure. These are prevented from penetration into the cavity of the drum 5.

The end of the drum 5 remote from the support plate 1 is closed by a cover 22.

In the case of temperature fluctuations there is a risk that an over-pressure or a sub-atmospheric pressure forms in the interior of the drum 5. Particularly in the case of sub-atmospheric pressure this can have the consequence of ingestion of undesired dirt and foreign matter through the seal 21. In order to prevent this a ventilation opening, which in this embodiment is realised by way of the support plate 1, is provided. The ventilation opening is thus arranged to be protected.

The outer side of the drum 5 can be formed in accordance with the respective purpose of use to be smooth, toothed or grooved and can also form a gearwheel or chainwheel.

By virtue of this construction the entire drive unit is very compact and extremely easy to clean. Nevertheless a high level of power density is achieved without the surroundings being unnecessarily heated. The drive unit is thereby particularly suitable for use in fields of hygiene, for example in preparation, cutting and packaging of foodstuffs. Transport belts which previously could be driven only with considerable complication can now be directly driven. In addition, the drive unit is readily controllable.

The transmission of the drive unit can have a self-locking configuration, whereby reverse rotation from the drive take-off side is excluded.

It is also conceivable to provide a motor brake (not illustrated) which similarly prevents reverse rotation, but which also prevents undesired free rotation of the drum 5. In addition, a rotational movement can, when needed, be stopped within a shortest time by response of the motor brake, such as may be desired, for example, in the case of actuation of an emergency ‘off’ switch.

It is also conceivable, as illustrated in FIGS. 7 and 8, for the drum 5 to be provided on its side remote from the support plate 1 with a stub shaft 71. In this embodiment the stub shaft 71 is connected with a closure cap 72 which engages over the drum 5 and is connected therewith to be secure against relative rotation. A screw or detent connection, for example, is conceivable here. Other connections are possible.

It is also conceivable to insert a cover into the end of the drum 5 and screw-connect it therewith. This cover then in turn carries the stub shaft 71.

The stub shaft 71 is here furnished with a groove 73 and a key 74 so as to ensure universal drive for a multiplicity of possibilities of use.

It is also conceivable for one or more support bearings for guidance of the stub shaft 71 to be provided. This is particularly advantageous in the case of longer stub shafts 71, since radial loading on the bearings of the drive unit 21 is thereby reduced. In addition, the possibilities of use are even more universal.

Transport belts in fields of hygiene are mostly composed of a plurality of individual belts or bands.

In order for direct drive by the drive unit 20 to also be made possible here, several drive units 20 can be arranged on a bracket 51.

In this embodiment the bracket 51 has the configuration of a U-shaped profile member.

Control units 52 for electric control of the drive units 20 can be provided within the U profile member. These control units 52 also make possible, for example, synchronisation of a plurality of drive units 20 on the bracket 51, so that synchronism of these drive units 20 is ensured.

The control units 52 are centrally supplied with energy.

In addition, a cooling system 53, which is coupled to the heat pipes 17 of the drive units 20, is provided in the bracket 51.

In that regard the cooling system 53 can itself consist of heat pipes 54, which are respectively coupled by way of heat exchangers 55 to the heat pipes 17. Other embodiments are conceivable. Thus, for example, an active cooling system can also be provided. The cooling system 53 conducts waste heat of the drive units 20 away from the hygiene area and thus ensures that the products to be processed are not unnecessarily heated. In that case it is also conceivable for waste heat to be discharged from the respective production facility. Multi-stage cooling systems are conceivable.

The ventilation openings can also open in the bracket 51. The bracket 51 can itself have a ventilation opening at a suitable location and otherwise be closed.

In addition, a central lubricant supply (not illustrated), which supplies the drive units 20 with lubricant, can be provided.

1.-27. (canceled)

28. A drive unit (20) in the form a driven drum (5), characterized in that provided within the drive unit (20) is a motor (6) and the outer side is formed as a smooth drum (5), a belt pulley, a cogged-belt pulley, a gearwheel and/or a chainwheel.

29. The drive unit according to claim 28, characterized in that the motor is configured as a drum motor, or a geared motor.

30. The drive unit according to claim 28, characterized in that the motor axle (2) is configured to be mounted at one end.

31. The drive unit according to claim 28, characterized in that the ratio of drum width to drum diameter is less than 2 and preferably is between 1 and less than 0.5.

32. The drive unit according to claim 28, characterized in that the motor axle (2) is of hollow configuration.

33. The drive unit according to claim 28, further comprising an angle measuring device arranged in the motor axle (2).

34. The drive unit according to claim 28, further comprising a single-stage or multi-stage transmission, particularly a cylindrical gear transmission, a planetary transmission, a cycloid transmission and/or an eccentric transmission, arranged at the end of the axle (2).

35. The drive unit according to claim 34, wherein the transmission is of self-locking configuration and/or a motor brake is provided.

36. The drive unit according to claim 34, wherein the transmission comprises a plurality of gearwheels (11, 13, 15) operating in parallel.

37. The drive unit according to claim 28, further comprising an axle suspension (1) that projects at one side or at multiple sides radially beyond the drum diameter, and optionally comprising a flange plate (1, 19) for securing the axle suspension is provided.

38. The drive unit according to claim 28, further comprising feed and discharge lines (18, 17) of the motor (6) configured to lead laterally beyond the axle (2).

39. The drive unit according to claim 28, further comprising heat conducting devices (17), particularly heat pipes for conducting away heat that is generated.

40. The drive unit according to claim 28, further comprising thermal insulation provided between the hollow axle (2) and drum (5), and optionally comprising a closure cover (22) configured to close the side of the drum (5) remote from the motor axle (2).

41. The drive unit according to claim 28, further comprising a stub shaft (71) arranged on the side of the drum (5) remote from the motor axle (2) and optionally comprising drive take-off devices (73, 74) and/or support bearings on the stub shaft (71).

42. The drive unit according to claim 28, characterized in that ventilation is realized via the axle suspension (1) of the drum body (5).

43. The drive unit according to claim 28, further comprising a seal (21) between the drum (5) and axle suspension (1).

44. A combination of a plurality of drive units of claim 28, characterized in that individual drive units (20) are securable to a bracket (51) by means of a defined interface with respect to mechanical securing, energy supply, lubricant supply and heat dissipation and thus form a combination of several drive units (20).

45. The combination of claim 44, characterized in that the bracket (51) is equipped with an electronic control system (52), a lubricant supply and/or a cooling system (53) for the individual drive units (20).

46. The combination of claim 45, characterized in that the cooling system (53) is configured with heat exchangers (55) for coupling to the individual drive units (20), and the cooling system (53) conducts generated heat outwardly to a provided point.

47. The combination according to claim 44, characterized in that a common energy supply and a common ventilation of the drive units (20) and the bracket (51) is provided.
